(19) United States
(12) Patent Application Publication
(10) Pub. No.: US 2007/0165693 A1
(43) Pub. Date: Jul. 19, 2007

(54) Methods and apparatus for reducing discrete power spectral density components of signals transmitted in multi-band wideband communications systems

(76) Inventors: Shaomin Samuel Mo, Monmouth Junction, NJ (US); Alexander D. Gelman, Smallwood, NY (US)

Correspondence Address: RATNERPRESTIA, P.O. BOX 980, VALLEY FORGE, PA, 19482, US

(21) Appl. No.: 10/555,163

(22) PCT Filed: Apr. 30, 2004
(86) PCT No.: PCT/US04/13210

§ 371 Date: Sep. 6, 2006

Related U.S. Application Data
(60) Provisional application No. 60/467,792, filed on May 2, 2003.

(51) Int. Cl. H04B 1/00

(52) U.S. Cl. 375/130

(57) ABSTRACT

Methods and apparatus for processing data for transmission that reduces discrete power spectral density (PSD) components of a transmitted multi-band wideband signal including the processed data are disclosed. Each band of the multi band wideband signal includes waveforms corresponding to a different band of frequencies. Data is processed for transmission by selectively inverting the data, defining a sequence for modulating the bands of the multi-band wideband signal with the data, and modulating the data onto the waveforms within the bands of the multiband wideband signal in accordance with the defined sequence.

### CROSS REFERENCE TO RELATED APPLICATIONS

This application claims the benefit of the filing date of provisional application Ser. No. 60/467,792 titled “Base-Band Data Whitening to Minimize Power Spectral Density of Multi-Band UWB Signals” filed May 2, 2003, incorporated fully herein by reference.

### FIELD OF THE INVENTION

The present invention relates to multi-band wideband communication systems and, more particularly, to methods and apparatus for reducing discrete power spectral density component of signals transmitted in multi-band wideband communication systems such as multi-band ultra wideband (UWB) communication systems.

### BACKGROUND OF THE INVENTION

Ultra wideband (UWB) technology uses base-band pulses of very short duration to spread the energy of transmitted signals very thinly from near zero to several GHz. UWB technology is presently in use in military applications and techniques for generating UWB signals are well known. Commercial applications will soon become possible due to a recent decision announced by the Federal Communications Commission (FCC) that permits the marketing and operation of consumer products incorporating UWB technology.

The key motivation for the FCC's decision to allow commercial applications is that no new communication spectrum is required for UWB transmissions because, when they are properly configured, UWB signals can coexist with other application signals in the same spectrum with negligible mutual interference. The FCC has specified emission limits for UWB applications to prevent interference with other communication systems.

The emission profile of a UWB signal can be determined by examining its power spectral density (PSD). Characterization of the PSD of a “Time-Hopping Spread Spectrum” signaling scheme in the presence of random timing jitter using a stochastic approach is disclosed in an article by Moe et al. titled “On the Power Spectral Density of Digital Pulse Streams Generated by M-ary Cyclostationary Sequences in the Presence of Stationary Timing Jitter.” See IEEE Tran. on Comm., Vol. 46, no. 9, pp. 1135-1145, September 1998. According to this article, the power spectra of UWB signals consists of continuous and discrete components. Discrete components create peaks in the PSD that may exceed the FCC emission limits even when the continuous components are well below these limits.

Multi-band modulation is a relatively new UWB modulation technique. In multi-band UWB communication systems, the UWB frequency band is divided into sub-bands and, in each sub-band, a different waveform that defines the sub-band is used.

There is an ever present desire to increase the communication distances of communication systems such as multi-band UWB communication systems. One way to Increase communication distance is to increase the power used for transmissions. To increase transmission power while still conforming to the FCC emission limits for UWB signals, it is desirable to reduce the discrete components so that overall power can be Increased while still conforming to the FCC emission limits for UWB signals. Accordingly, Improved methods and apparatus for reducing discrete PSD components of multi-band UWB signals are needed. The present invention fulfills this need among others.

### SUMMARY OF THE INVENTION

The present invention is embodied in methods and apparatus for processing data for transmission that reduces discrete power spectral density (PSD) components of a transmitted multi-band wideband signal including the processed data. Each band of the multi-band wideband signal includes waveforms corresponding to a different band of frequencies. Data is processed for transmission by selectively inverting the data, defining a sequence for modulating the bands of the multi-band wideband signal with the data, and modulating the data onto the waveforms within the bands of the multi-band wideband signal In accordance with the defined sequence.

### BRIEF DESCRIPTION OF THE DRAWINGS

The invention is best understood from the following detailed description when read in connection with the accompanying drawings, with like elements having the same reference numerals. Included in the drawings are the following figures:

FIG. 1 is a block diagram of an exemplary multi-band wideband communication system in accordance with the present invention;

FIG. 1A is a block diagram of an alternative exemplary transmitting apparatus of use in the exemplary multi-band wideband communication system of FIG. 1;

FIG. 1B is a block diagram of an alternative exemplary receiving apparatus for use in the exemplary multi-band wideband communication system of FIG. 1;

FIG. 2 is a block diagram of an exemplary multi-band mapping scheme for use by a transmitter and a receiver in the exemplary multi-band wideband communication system of FIG. 1;

FIG. 3 is a flow chart of exemplary transmitting steps in accordance with the present invention;

FIG. 4 Is a flow chart of exemplary receiving steps in accordance with the present invention;

FIG. 5 (prior art) is a graph of amplitude versus time that is useful for describing multi-band UWB transmissions;

FIG. 6 is a data diagram that is useful for describing a simulation technique used to evaluate the effectiveness of the exemplary methods according to the present invention;

FIG. 7 is a data diagram that is useful for describing a multi-band UWB transmission according to the present invention;

FIGS. 8A, 9A, 10A, 11A, 12A, and 13A are graphs of amplitude versus time that illustrate exemplary binary phase shift key (BPSK) multi-band waveforms used in exemplary methods according to the subject invention;

FIGS. 8B, 9B, 10B, 11B, 11B and 13B are graphs of amplitude versus frequency that illustrate frequency spectra of the waveforms shown in FIGS. 8A, 9A, 10A, 11A, 12A and 13A, respectively;

FIGS. 8C, 9C, 10C, 11C, 12C and 13C are graphs of amplitude versus frequency that represent frequency spectra of the modulated multi-band UWB signal before application of the present invention;

FIGS. 8D, 9D, 10D, 11D, 12D and 13D are graphs of amplitude versus frequency that represent frequency spectra of the modulated multi-band UWB signal after application of the present invention;

FIGS. 14A, 15A, 16A, 17A, 18A and 19A are graphs of amplitude versus time that illustrate exemplary quadrature phase shift key (QPSK) multi-band waveforms used in exemplary methods according to the subject Invention;

FIGS. 14B, 15B, 16B, 17B, 18B and 19B are graphs of amplitude versus frequency that illustrate frequency spectra of the waveforms shown in FIGS. 14A, 15A, 16A, 17A, 18A and 19A, respectively;

FIGS. 14C, 15C, 16C, 17C, 18C and 19C are graphs of amplitude versus frequency that represent frequency spectra of the modulated multi-band UWB signal before application of the present invention; and

FIGS. 14D, 15D, 16D, 17D, 18D and 19D are graphs of amplitude versus frequency that represent frequency spectra of the modulated multi-band UWB signal after application of the present invention.

### DETAILED DESCRIPTION OF THE INVENTION

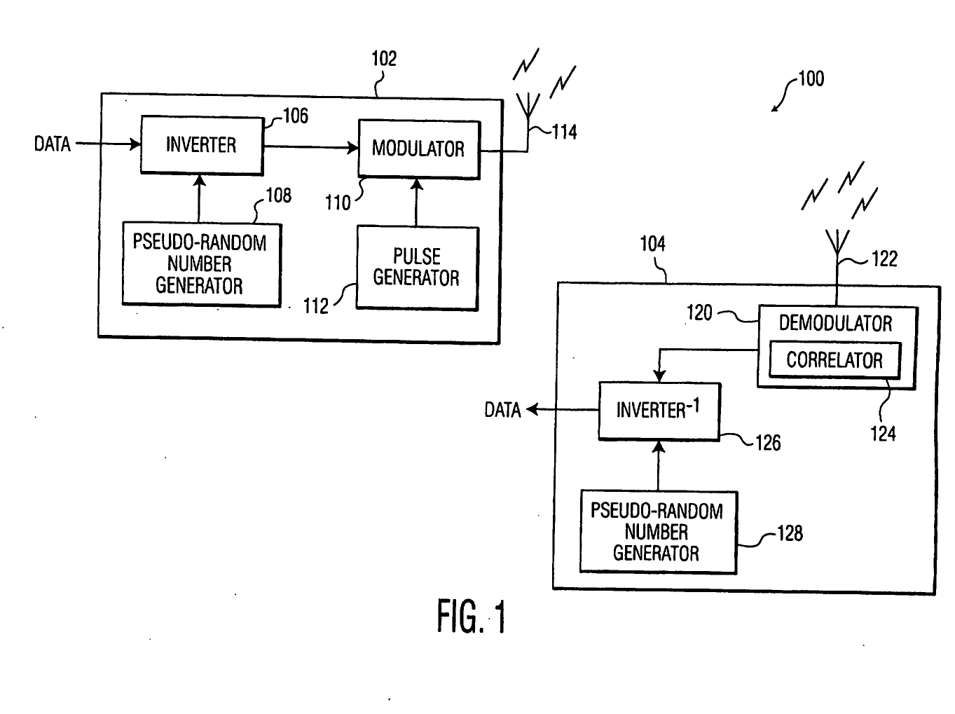

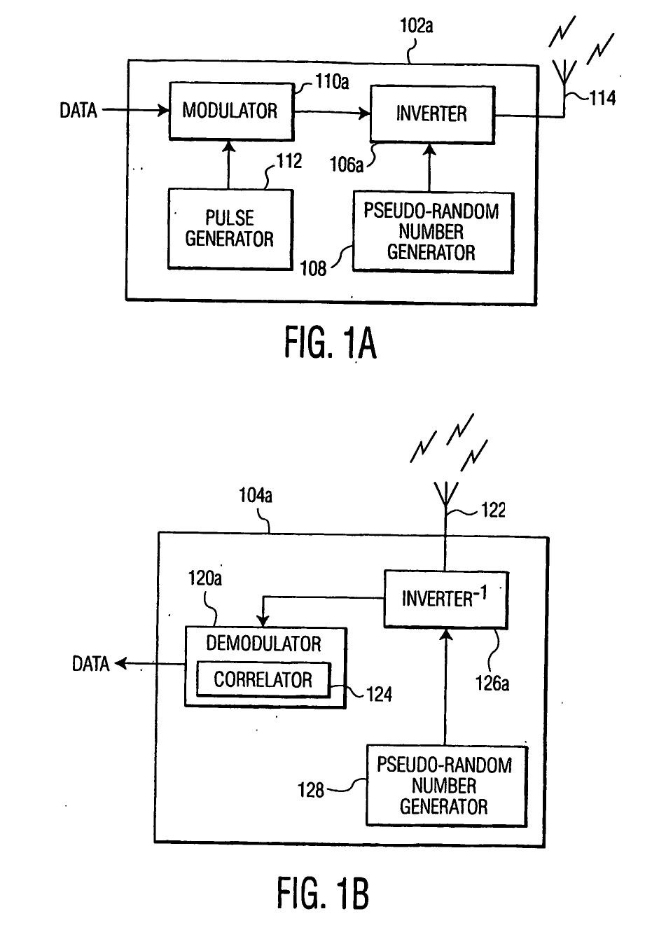

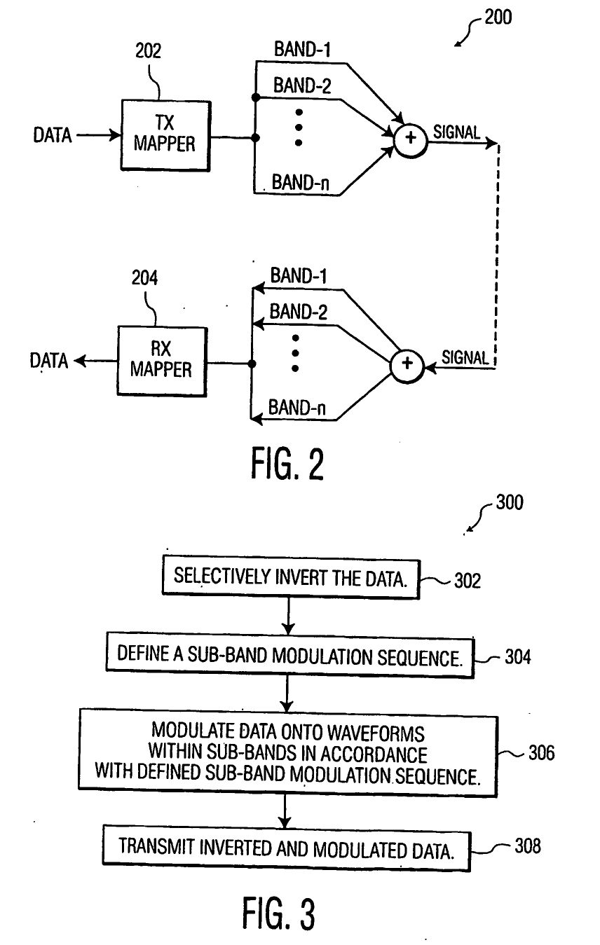

FIG. 1 is a conceptual representation of an exemplary multi-band wideband communication system 100 in accordance with the present invention. Functions of one or more blocks within the illustrated communication system 100 can be performed by the same piece of hardware or module of software. It should be understood that embodiments of the present invention may be implemented in hardware, software, or a combination thereof. In such embodiments, the various component and steps described below may be implemented in hardware and/or software.

In general overview, a transmitting apparatus 102 for transmitting data selectively inverts the data for transmission in bands of a multi-band wideband transmission signal to reduce the discrete power spectral density (PSD) components of the transmitted signal. A receiving apparatus 104 receives the multi-band wideband transmission signal and reverses the inversion to recover the original data. The data may be mapped to the multi-bands in a sequential or random sequence. The data may be data bits or symbols representing one or more data bits.

The components of the transmitting apparatus 102 and the receiving apparatus 104 are now described in detail. In an exemplary embodiment, to prepare the data for transmission, the data is applied to an inverter 106. The inverter 106 inverts the data according to a predetermined inverting function. In an exemplary embodiment, the inverter 106 is coupled to a pseudo-random number generator 108 that generates pseudo random binary numbers that are evenly distributed. The inverter 106 may be a multiplexer (not shown) that passes the data or the inverse of the data, e.g., as inverted by an inverter circuit (not shown), responsive to the pseudo-random binary numbers.

A modulator 110 is coupled to a pulse generator 112 that generates a wideband pulse signal made up of a series of signal pulses such as ultra wideband (UWB) signal pulses. In an exemplary embodiment, the modulator 110 modulates the selectively inverted data in digital format onto the multi-band wideband signal for transmission via an antenna 114. The modulator 110 may be a pulse modulator as shown or it may be a digital-to-analog converter (not shown) with a pulse shaping circuit (not shown).

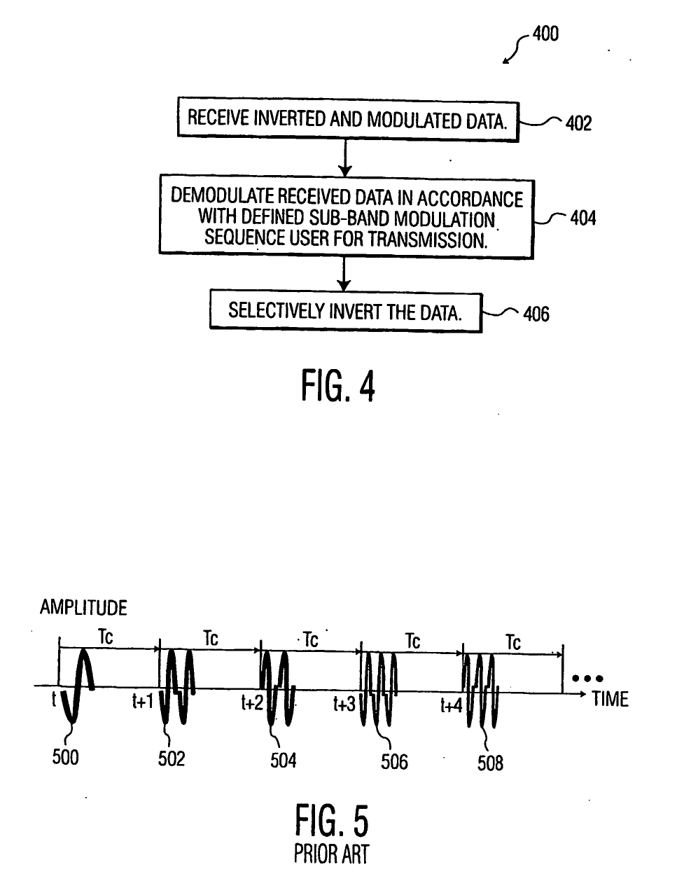

The modulator 110 defines a sequence for modulating the data onto waveforms within the bands of the multi-band transmission signal. FIG. 2 depicts an exemplary multi-band mapping scheme 200 for mapping data to the multi-bands in accordance with the defined sequence for transmission. The exemplary mapping scheme 200 includes a transmitting (TX) mapper 202 (which may be incorporated into the modulator 110 of the transmitting apparatus 102, see FIG. 1) and a corresponding receiving (RX) mapper 204 (which may be incorporated into a demodulator 120 of the receiving apparatus 104, see FIG. 1). The TX mapper 202 maps the data to the bands of the multi-band transmission signal in accordance with the defined sequence for transmission and the RX mapper 204 demaps the data from the bands to recover the data in the correct sequential order.

The defined sequence may be sequential or random. When a sequential sequence is defined, the TX mapper 202 sequentially maps the data to the multi-bands in a predefined order that may be in a numerically increasing (or decreasing) order or in another order. For example, the predefined order may be a first band (band-1), then a second band (band-2), and then a third band. The data Is then mapped to the bands in this order, which is repeated until the data transmission is complete. Alternatively, the predefined sequence may be the second band (band-2), then the first band (band-1), then the third band. When a random sequence is defined, the TX mapper 202 randomly maps the data to the multi-bands. For example, a first sequence for mapping may be a randomly selected sequence such as the first band (band-1), then the second band (band-2), and then the third band. The next sequence may be another randomly selected sequence such as the second band (band-2), then the first band (band-1), and then the third band. Each subsequent sequence would likewise be a randomly selected sequence.

Where the sequence is random, the TX mapper 202 and the RX mapper 204 each Include a random number generator (not shown). A suitable random number generator for use by the TX mapper 202 will be understood by those of skill in the art. In an exemplary embodiment, a similar random number generator is used in the RX mapper 204. The random number generator In the RX mapper 204 is synchronized to the data received at the RX mapper 204 in a manner that will be understood by those of skill in the art.

FIG. 1A depicts an alternative exemplary transmitting apparatus 102a. The transmitting apparatus 102a is similar to the transmitting apparatus 102 of FIG. 1 with the exception that the inverter 106a is positioned after the modulator 110a. In this embodiment, the data is modulated onto the waveforms of the wideband signal prior to inversion. The inverter then selectively inverts the wideband signal waveforms responsive to the pseudo-random number generator 128. A suitable inverter 106a for selectively inverting the modulated wideband waveforms will be understood by those of skill in the art.

Referring back to FIG. 1, in an exemplary embodiment, a demodulator 120 within the receiving apparatus 104 receives the inverted multi-band wideband signal through another antenna 122. The demodulator 120 demodulates and reorders (demaps) the data from the multi-bands in accordance with the mapping sequence used by the modulator 110 (see FIG. 2 and the corresponding description above). A correlator 124 within the demodulator 120 correlates the received data to the pulse shape used by the transmitting apparatus 102 to identify pulses and convert them to digital pulses. In an exemplary embodiment, the correlator 124 is a matched filter correlator configured to identify and correlate incoming wideband pulses such as UWB pulses.

An inverter⁻¹ 126 reverses the inversion introduced to the data by the inverter 106 according to a predefined inverting function that is based on the inverting function of the inverter 106. In an exemplary embodiment, the inverter⁻¹ 126 is coupled to a pseudo-random number generator 128 that is substantially identical to the pseudo-random number generator 108 described in detail above (and, thus, is not described in further detail here). The inverter⁻¹ 126 may be a multiplexer (not shown) which passes the data or the inverse of the data, e.g., as Inverted by an inverter logic circuit (not shown), responsive to select bits generated by the pseudo-random number generator 128.

The two pseudo-random number generators 110 and 128 generate identical bit-strings. In an exemplary embodiment, for synchronization, the generators 110 and 128 are configured to start at a common point when the first bit of a data sequence Is transmitted or received. In an alternative exemplary embodiment, instead of generating random numbers, a set of random numbers are generated in advance and stored into an array. The same array is kept in the pseudo-random number generators 110, 128 in both the transmitting apparatus 102 and the receiving apparatus 104 for use in selectively inverting and un-inverting, respectively, the data.

FIG. 1B depicts an alternative exemplary receiving apparatus 104a. The receiving apparatus 104a is similar to the receiving apparatus 104 of FIG. 1 with the exception that the inverter⁻¹ 126a is positioned before the demodulator 120a. In this embodiment, the selective inversion introduced by the inverter (inverter 106 of FIG. 1 or inverter 106a of FIG. 1A) is reversed prior to demodulation. A suitable inverter⁻¹ 126a for reversing the inversion will be understood by those of skill in the art.

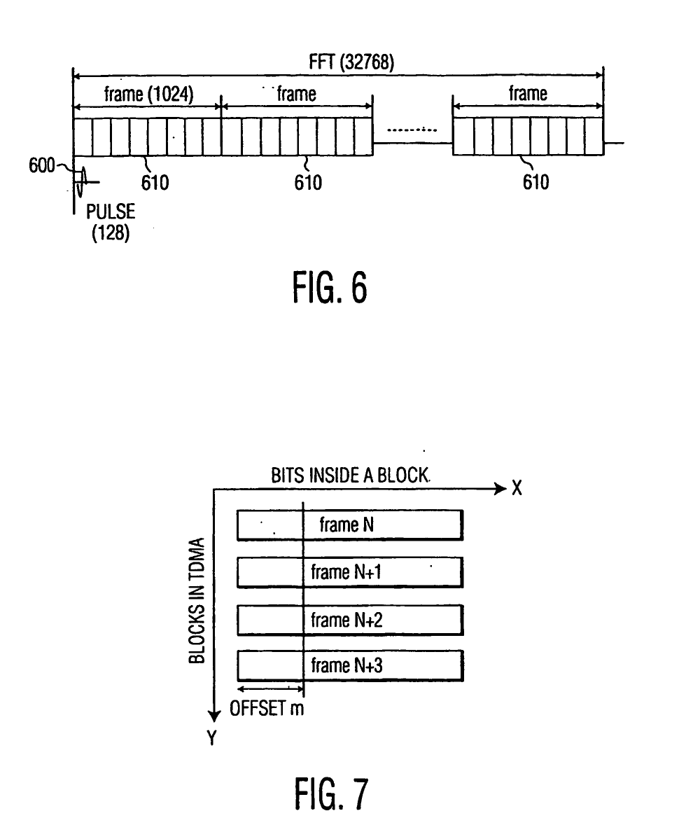

FIG. 3 depicts a flow chart 300 of exemplary transmitting steps for reducing discrete PSD components in a multi-band wideband communication system such as a multi-band UWB communication system. The steps of flow chart 300 are described with reference to the components of FIG. 1.

At block 302, the inverter 106 selectively inverts the data responsive to pseudo-random data received from the pseudo-random number generator 110.

At block 304, a sub-band modulation sequence is defined, e.g., by the modulator 110, for modulating the data onto the waveforms within the bands of the multi-band wideband signal. In an exemplary embodiment, the sequence is sequential. In an alternative exemplary embodiment, the sequence is random.

At block 306, the modulator 110 modulates the inverted data onto waveforms within the sub-bands in accordance with the sequence defined at block 304. The data may be prepared for transmission by using it to modulate pulses provided by the pulse generator 112 in accordance with the defined sequence.

At block 308, the inverted and modulated data is transmitted from the antenna 114.

In an alternative exemplary transmission embodiment, the data may be modulated onto the sub-bands of the multi-band signal in accordance with the defined sequence prior to inversion. In accordance with this embodiment, the inversion step in block 302 is performed after the modulating step in block 306.

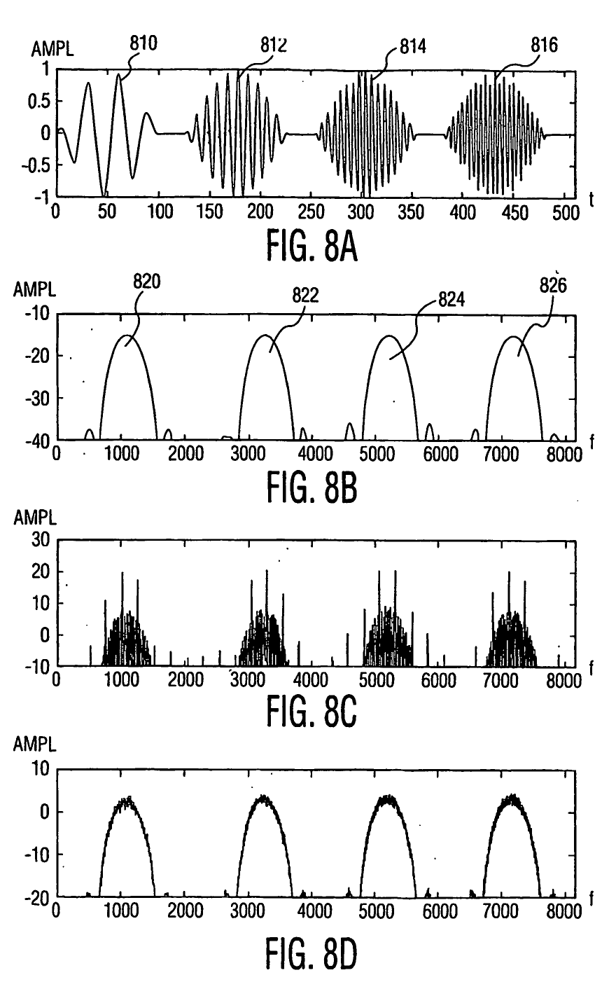

FIG. 4 depicts a flow chart 400 of exemplary receiving steps for receiving multi-band wideband signals that are inverted and modulated in accordance with the present invention. The steps of flow chart 400 are described with reference to the components of FIG. 1.

At block 402, the demodulator 120 within the receiving apparatus 104 receives the inverted and modulated data through the antenna 122. In an exemplary embodiment, the correlator 124 within the demodulator 120 correlates the data to identify the wideband signal carrying the data.

At block 404, the receiver demodulates the received multi-band wideband signal in accordance with the sub-band modulation sequence used for modulation in block 304 (FIG. 3).

At block 406, the inverter⁻¹ 126 reverses the inversion introduced by the inverter 106 responsive to a pseudo-random number sequence or stream generated by the pseudo-random number generator 128. In an exemplary embodiment, the pseudo-random number generator 128 is configured to start when a designated bit is received, e.g., a first bit of a received sequence.

In an alternative exemplary receiving embodiment, the received wideband signal is first selectively inverted and then demodulated. In accordance with this embodiment, the Inversion step in block 406 is preformed before the demodulation step in block 404.

Additional implementation details are now provided for the exemplary communication system 100 described above with reference to FIGS. 1, 2, 3, and 4.

To better understand the operation of the present invention, It is useful to describe the PSD of a multi-band UWB sequence. The multi-band UWB sequence is used in the proposed standard being discussed by a working committee of the Institute for Electrical and Electronics Engineers (IEEE), namely, the IEEE 802.15.3a task group of the IEEE 108.15 working group for wireless personal area networks (WPAN).

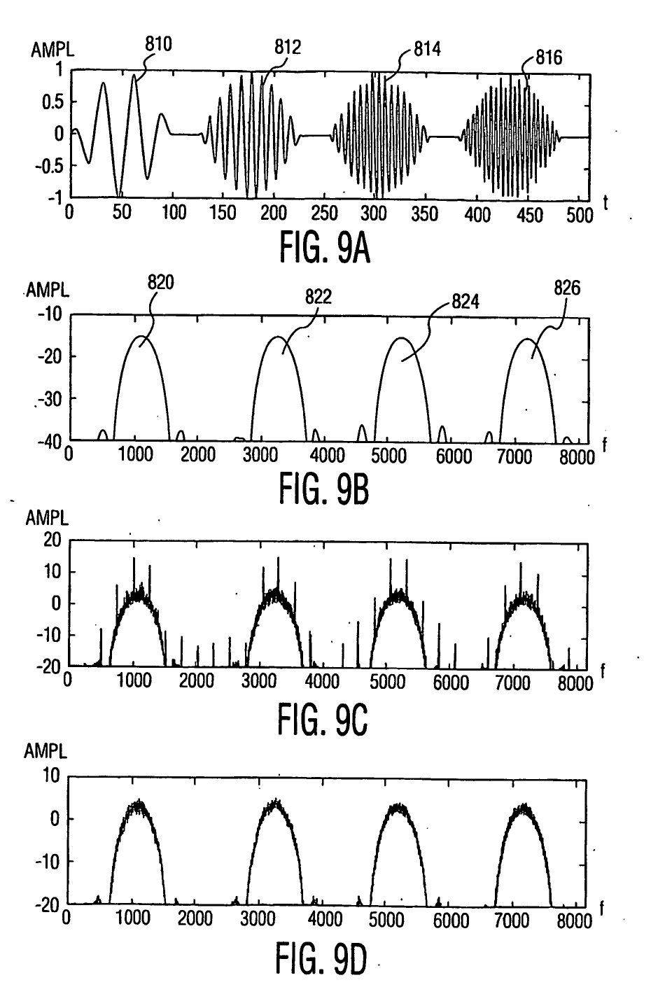

In the multi-band UWB communication systems, a digitally controlled signal produces random transmissions at multiples of the basic clock period Tc. This signaling technique is shown in FIG. 5 and may be modeled as shown in equation (1).

$$s ( t ) = {\sum }_{n = - ∞}^{∞} {a}_{n} {w}_{n} ( t - {nT}_{c} ) \qquad ( 1 )$$

In equation (1), the factor {aₙ} is an unbalanced binary independent identically distributed (i.i.d.) random sequence and t is time. The probability function of {aₙ}, Pr{aₙ}, is given by equation (2).

$$Pr \{ {a}_{n} \} = \{ \begin{matrix}p , & {a}_{n} = 1 \\ 1 - p , & {a}_{n} = - 1\end{matrix} \qquad ( 2 )$$

Also in equation (1), the factor {wₙ} is random variable applied to a set of waveforms that define the number (N) of sub-bands in the multi-band system. The probability function of {wₙ} is subject to the constraints of equations (3) and (4).

$$\begin{matrix}Pr \{ {w}_{n} \} = {p}_{n} , n = 1 , … , N & ( 3 ) \\ {\sum }_{n = 1}^{N} {p}_{n} = 1 & ( 4 )\end{matrix}$$

In FIG. 5, the waveforms 500, 502, 504, 506, and 508 define the different sub-bands. The waveforms 502 and 504 are in the same sub-bands but have opposite polarity, as do the waveforms 506 and 508. Thus, the waveforms 500, 502, and 506 are produced responsive to different values of {wₙ,} while the pairs of waveforms 502, 504 and 506, 508 are produced responsive to different values of {aₙ}.

The PSD of the signal shown in FIG. 5 consists of a continuous component, S^{c}(f) and a discrete component, S^{d}(f). These components may be characterized as shown in equation (5).

$${S}^{c} ( f ) = \frac{1 - {( 2 p - 1 )}^{2}}{Tc} {\vert {\sum }_{n = 1}^{N} {p}_{n} {W}_{n} ( f ) ( u ( \begin{matrix}f - \\ ( {f}_{n} - \frac{{f}_{B}}{2} )\end{matrix} ) - u ( \begin{matrix}f - \\ ( {f}_{n} + \frac{{f}_{B}}{2} )\end{matrix} ) ) \vert}^{2} \\ {S}^{d} ( f ) = \frac{{( 2 p - 1 )}^{2}}{{Tc}^{2}} {\sum }_{l = - ∞}^{∞} {\vert {\sum }_{n = 1}^{N} {p}_{n} {W}_{n} ( \frac{l}{Tc} ) ( \begin{matrix}u ( \begin{matrix}f - \\ ( {f}_{n} - \frac{{f}_{B}}{2} )\end{matrix} ) - \\ u ( \begin{matrix}f - \\ ( {f}_{n} + \frac{{f}_{B}}{2} )\end{matrix} )\end{matrix} ) \vert}^{2} {δ}_{D} ( f - \frac{l}{Tc} ) \qquad ( 5 )$$

In equation (5), u( ) is a step function, fₙ is the center frequency of each sub-band and f_{B} is the bandwidth of each sub-band. Equation (5) can be rewritten in a simplified form as shown in equation (6).

$${S}^{c} ( f ) = \frac{1 - {( 2 p - 1 )}^{2}}{Tc} {\vert {p}_{n} {W}_{n} ( f ) \vert}^{2} \\ {S}^{d} ( f ) = \frac{( 2 p - 1 )}{{Tc}^{2}} {\sum }_{l = - ∞}^{∞} {\vert {p}_{n} {W}_{n} ( \frac{l}{Tc} ) \vert}^{2} {δ}_{D} ( f - \frac{l}{Tc} ) , \\ 1 \leq n \leq N \qquad ( 6 )$$

Equation (6) indicates that the PSD is determined by four factors: Wₙ(f), the pulse shape and transmission power in a sub-band; Tc, the clock period or pulse rate; p the distribution of the random variable aₙ; and pₙ the distribution of the random variable wₙ.

When the inversion or non-inversion of a symbol have equal probabilities, as described by equation (7)
p=0.5 (7)

spectral lines in each sub-band are effectively removed. Thus, the PSD of each sub-band is minimized. The new PSD may be expressed by equation (8).

$${S}^{c} ( f ) = \frac{l}{Tc} {\vert {p}_{n} {W}_{n} ( f ) \vert}^{2} \\ {S}^{d} ( f ) = 0 , \\ 1 \leq n \leq N \qquad ( 8 )$$

The energy spectral density of the waveforms, Wₙ(f), differ from one another in magnitude and their peak values, Ŵₙ, are defined as shown in equation (9).

$${\hat{W}}_{n} = {max}_{f} ( {W}_{n} ( f ) ) \qquad ( 9 )$$

In order to minimize the peak values of the PSDs of the whole system, pᵢ is chosen to satisfy equation (10).

$${p}_{i} {W}_{i} = {p}_{j} {W}_{j} , \\ 1 \leq i , j \leq N , and \\ i \neq j \\ {\sum }_{i = 1}^{N} {p}_{i} = 1 \qquad ( 10 )$$

Equation (10) can be solved as shown in equation (11).

$${p}_{i} = \frac{1}{{\hat{W}}_{i} {\sum }_{n = 1}^{N} \frac{1}{{\hat{W}}_{n}}} , i = 1 , … , N \qquad ( 11 )$$

The inventors have determined that the peak value in each sub-band is a constant with their value given by equation (12).

$${p}_{i} {\hat{W}}_{i} = \frac{1}{{\sum }_{n = 1}^{N} \frac{1}{{\hat{W}}_{n}}} \qquad ( 12 )$$

The second part of equation (10) may be verified by equation (13).

$${\sum }_{i = 1}^{N} {p}_{i} = {\sum }_{i = 1}^{N} \frac{1}{{\hat{W}}_{i} {\sum }_{n = 1}^{N} \frac{1}{{\hat{W}}_{n}}} = \frac{1}{{\sum }_{n = 1}^{N} \frac{1}{{\hat{W}}_{n}}} {\sum }_{i = 1}^{N} \frac{1}{{\hat{W}}_{i}} = 1 \qquad ( 13 )$$

If peak value of each Wₙ(f) is the same, or, as shown in equation (14),
Ŵᵢ=Ŵⱼ, 1≦i,j≦N and i≠j (14)

equation (11) may be rewritten as equation (15).

$${p}_{i} = \frac{1}{N} , i = 1 , … , N \qquad ( 15 )$$

Combining equations (7) and (15), it is noted that in order to reduce the peak PSD level of the whole systems, the following two conditions are desirably met: (

$$( p = 0.5 and {p}_{n} = \frac{1}{N} , n = 1 , … , N ) .$$

One way to Implement equation (15) is to sequentially rotate through each sub-band when sending data.

Based on the preceding analysis of the PSD of multi-band UWB signals, the following mechanism of selective phase reversion is proposed to eliminate spectral lines in the PSD of the modulated multi-band UWB signals. The exemplary method includes the following steps:

Generating a random sequence {bₙ} with the evenly distributed function defined by equation (16);

$$Pr \{ {b}_{n} \} = \{ \begin{matrix}0.5 , & {b}_{n} = 1 \\ 0.5 , & {b}_{n} = - 1\end{matrix} \qquad ( 16 )$$

Performing an exclusive OR (XOR) operation on sequences {aₙ} and {bₙ} to produce a new sequence {cₙ} as shown in equation (17); and
cₙ=aₙ⊕bₙ (17)

Using the sequence {cₙ} as the new data for transmission.

Performing the above operation effectively removes spectral lines in PSD of UWB signals in each sub-band, which is equivalent to minimizing the PSD in each sub-band.

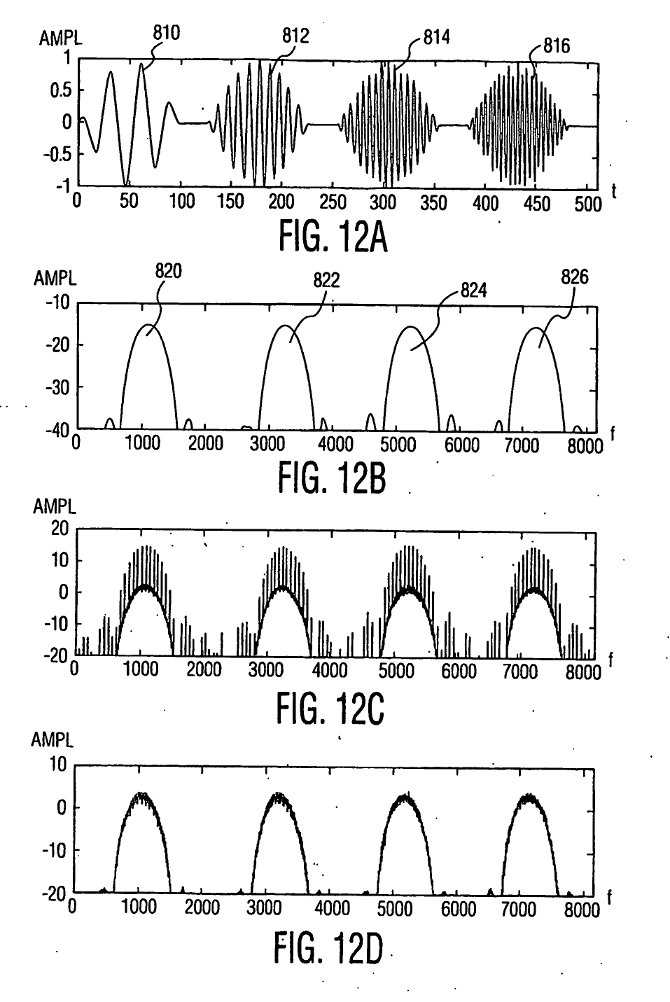

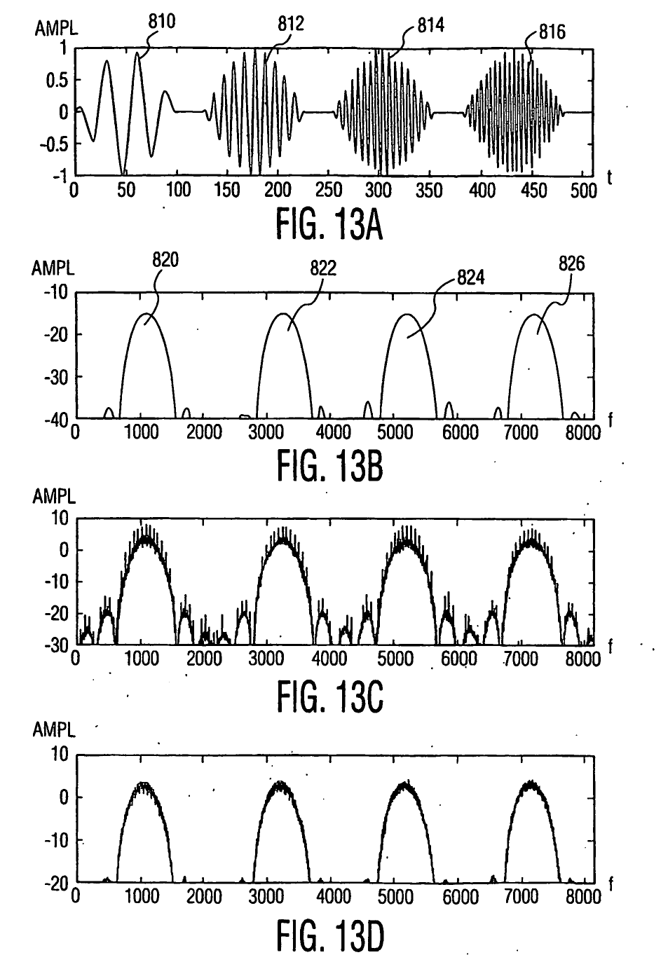

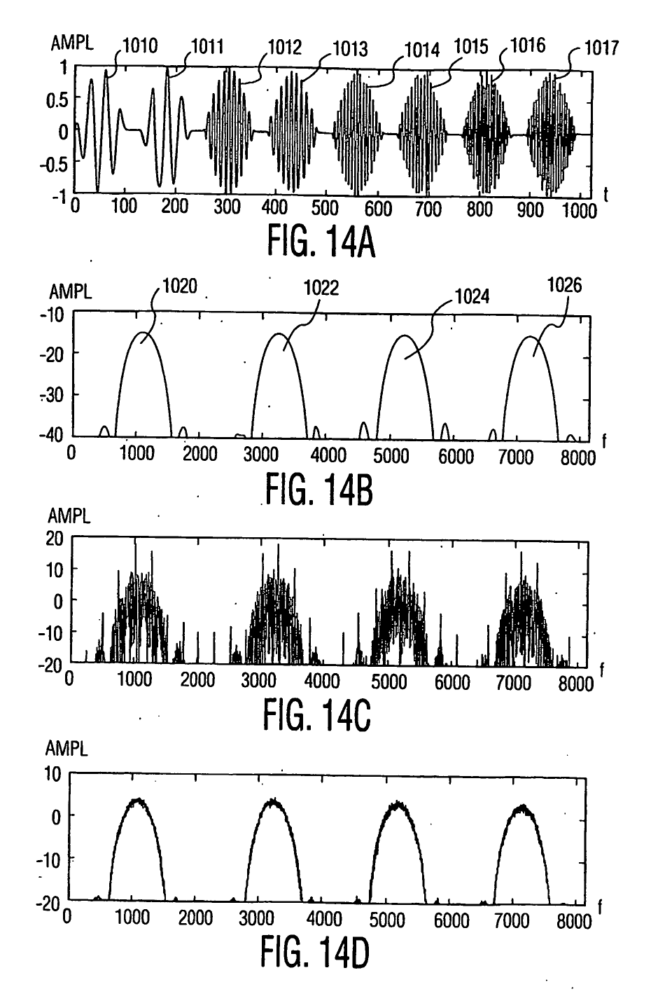

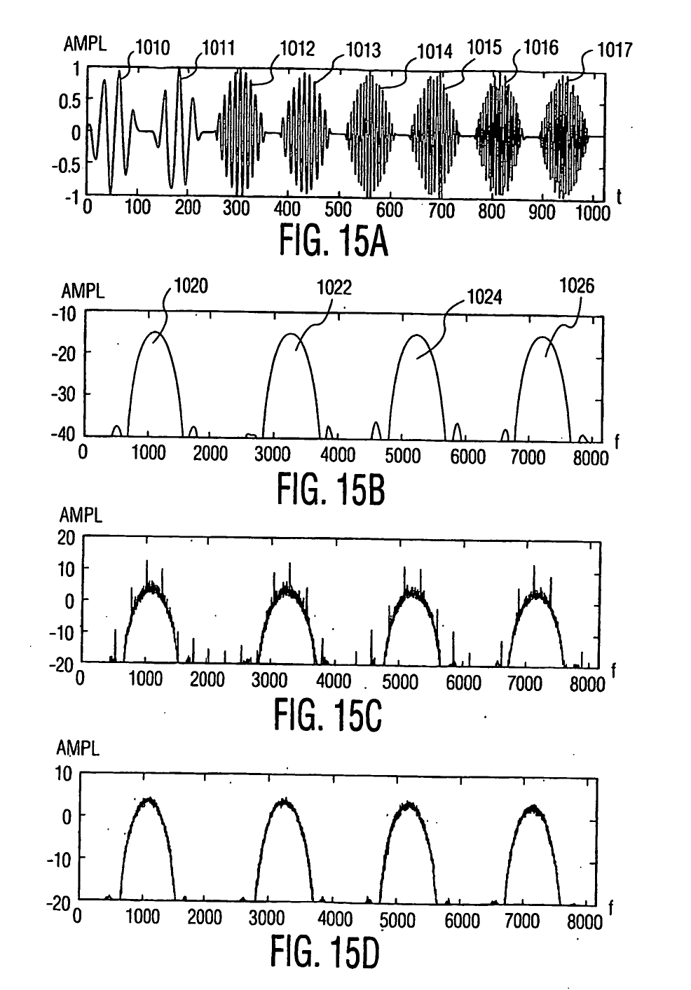

FIGS. 8-19 show the results of simulations that apply the operations represented in equation (16) and (17). These simulations show that these operations effectively suppress line spectra and, thus, reduce the PSD of multi-band UWB signals.

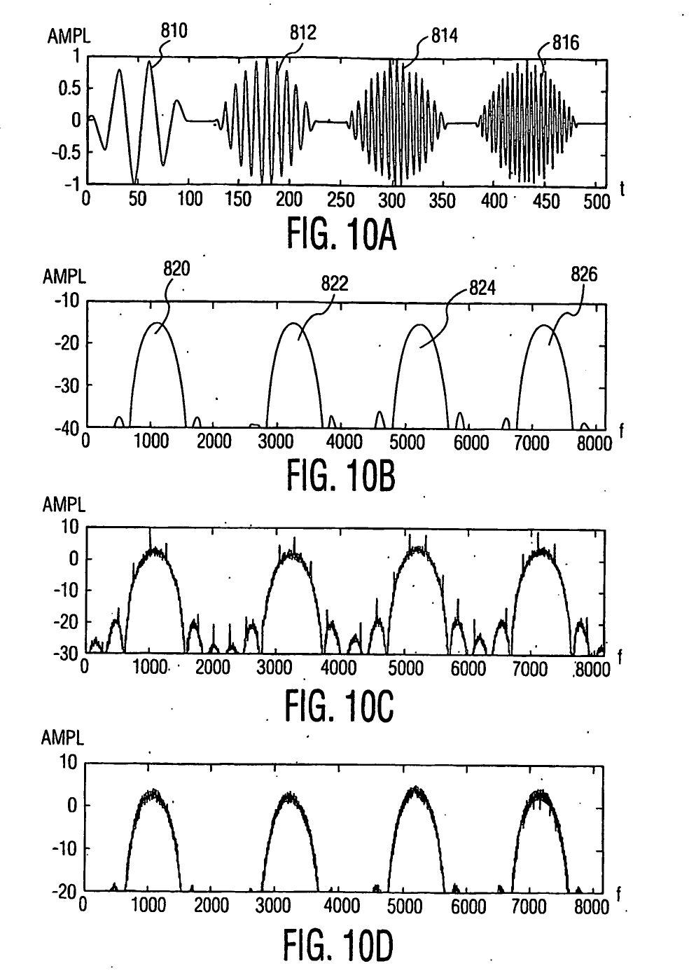

The configuration of the simulations is shown in FIG. 6. The simulations use Periodogram PSD estimators to calculate the PSD of different UWB signals. In the configuration employed, a pulse 600, is represented by 101 samples followed by 27 samples of zero padding. A bit consists of one pulse and is represented by 128 samples. Each frame, 610, having a period, Tc, includes 1024 samples. A 32768-point fast Fourier transform (FFT) operation is used on 32768 samples to evaluate the PSD. In other words, the FFT is based on 32 frames and each frame includes eight pulses. Because a single estimate may generate a large bias in estimation and because the FCC regulation sets a limit on average PSD, each of the simulations uses 50 runs to smooth the final PSD estimate.

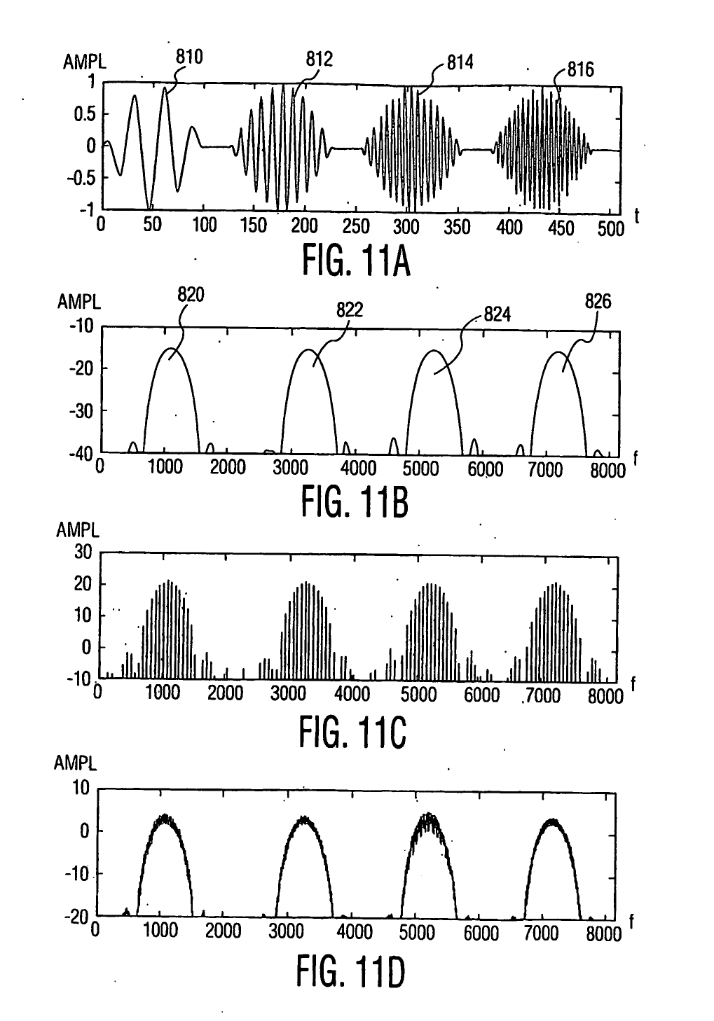

The data diagram of FIG. 7 illustrates the relationship of data generated in the simulation. In FIG. 7, the X direction represents bits in one block of a time division multiple access (TDMA) system and the Y direction represents bits with the same offset, offset m, from the beginning of the block. As described above, when pulses are randomly and evenly distributed in the Y direction, line frequencies can be effectively suppressed.

In the simulation, data in the X direction is randomly and evenly generated. This results in equation (18).

$${p}_{n} = \frac{1}{N} , n = 1 , … , N \qquad ( 18 )$$

In the Y direction, however, the generation of data is controlled by the distribution function of {aₙ}, or p. The simulations shown in FIGS. 8-19 represent only the cases of: sub-bands being evenly and randomly used (see FIGS. 8, 9, 10, 14, 15 and 16); sub-bands being used rotationally (see FIGS. 11, 12, 13, 17, 18 and 19); p=1, (i.e., equivalent to unchanged data between frames, see FIGS. 8, 11, 14 and 17); 0<p<0.5, (i.e. the data is not evenly distributed in the Y direction, see FIGS. 9, 10, 12, 13, 15, 16, 17 and 19).

The results of simulations using a binary phase shift key modulation (BPSK) technique are shown in FIGS. 8 to 13. FIGS. 8A, 9A, 10A, 11A, 12A and 13A show the waveforms 810, 812, 814 and 816 used in the simulations. These waveforms are the same for FIGS. 8-13 and, thus, are discussed with reference to FIG. 8 only. Each of these waveforms corresponds to a respectively different band of frequencies as shown in FIG. 8B. In FIGS. 8-13, the waveform 810, having the lowest frequency components, corresponds to the frequency spectrum 820, the waveform 812 corresponds to the frequency spectrum 822, the waveform 814 corresponds to the frequency spectrum 824 and the waveform 816 corresponds to the frequency spectrum 826. The waveforms 810, 812, 814 and 816 are shown in that order in FIG. 8A so that they are aligned with their respective frequency spectra 820, 822, 824 and 826. As described below, however, these waveforms may appear in any order In a particular transmission.

FIGS. 8C, 9C, 10C, 11C, 12C and 13C show the PSDs of exemplary original data {aₙ} modulated on the waveforms 8A, 9A, 10A, 11A, 12A and 13A, respectively. As can be seen, for example, from FIG. 8C, this modulated data exhibits relatively large discrete frequency components (i.e. spectral lines in the PSD). FIGS. 8D, 9D, 10D, 11D, 12D and 13D show the result on the PSD when the data shown in the respective FIGS. 8C, 9C, 10C, 11C, 12C and 13C is processed according to the present invention, (i.e. PSD of resulting data {cₙ} after operations described in equation (16) and (17)).

As described above, FIGS. 8-13 illustrate different configurations of sequencing of the waveforms 810, 812, 814 and 816 and different distributions of the probability function p of the random variable {aₙ}. In particular, FIG. 8C represents the case in which p=1 and the waveforms are randomly and equally used; FIG. 9C shows the case in which p=0.25 and the waveforms are randomly and equally used; FIG. 10C shows the case in which p=0.4 and the waveforms are randomly and equally used.

FIGS. 11, 12, and 13 represent cases in which the waveforms are sequentially and rotationally used (e.g., 810, 812, 814, 816, 810, etc.). FIGS. 11C, 12C, and 13C show the cases where p equals 1, 0.25 and 0.4, respectively.

The results indicate that, using methods according to the present invention:

Random utilization of sub-bands reduces the number of lines compared with rotational use of sub-bands. The peak of the PSD, however, is almost the same, as shown in FIGS. 8C, 9C, 10C, 11C, 12C and 13C;

Selective phase inversion effectively removes line spectra in both cases no matter how sub-bands are utilized, as shown in FIGS. 8D, 9D, 10D, 11D, 12D and 13D;

In the illustrated examples, the peak values of the PSDs are reduced from about from 21 dB to 4 dB in FIGS. 8 and 11, from 14 dB to 4 dB in FIGS. 9 and 12, and from 9 dB to 4 dB in FIGS. 10 and 13;

The shape of the PSD of the new data, shown in FIGS. 8D, 9D, 10D, 11D, 12D and 13D, is very close to that of the waveforms shown in 8B, 9B, 10B, 11B, 12B and 13B;

With the equal use of all sub-bands, the respective PSDs of the sub-bands have almost the same magnitude.

In the embodiment described above, the function {aₙ} is, in fact, a BPSK modulation. In this system, each sub-band has one waveform and each waveform appears in two ways: normal shape and phase reversed shape.

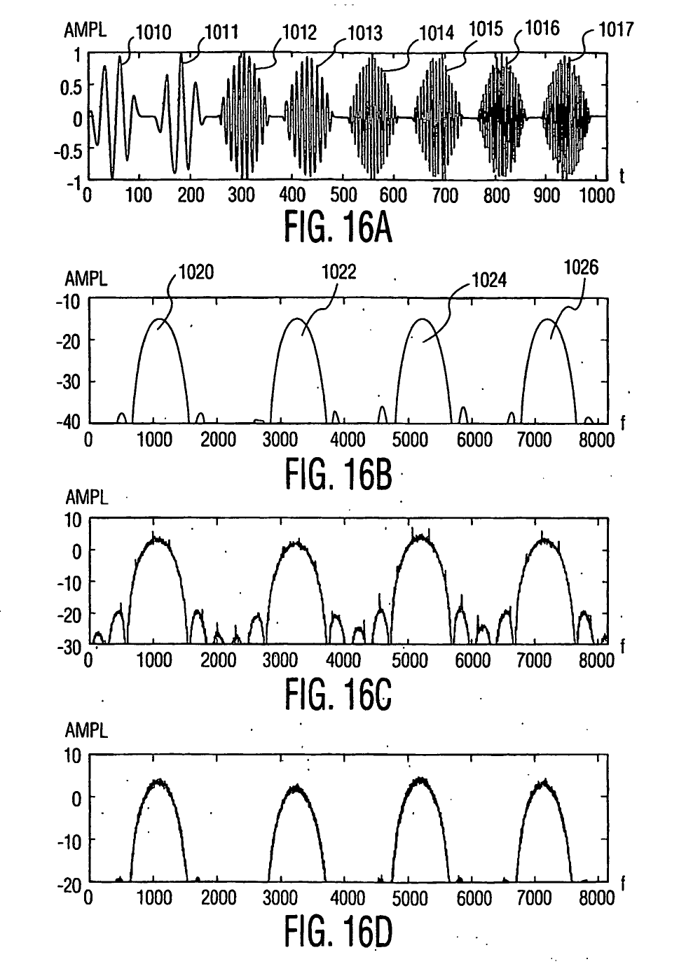

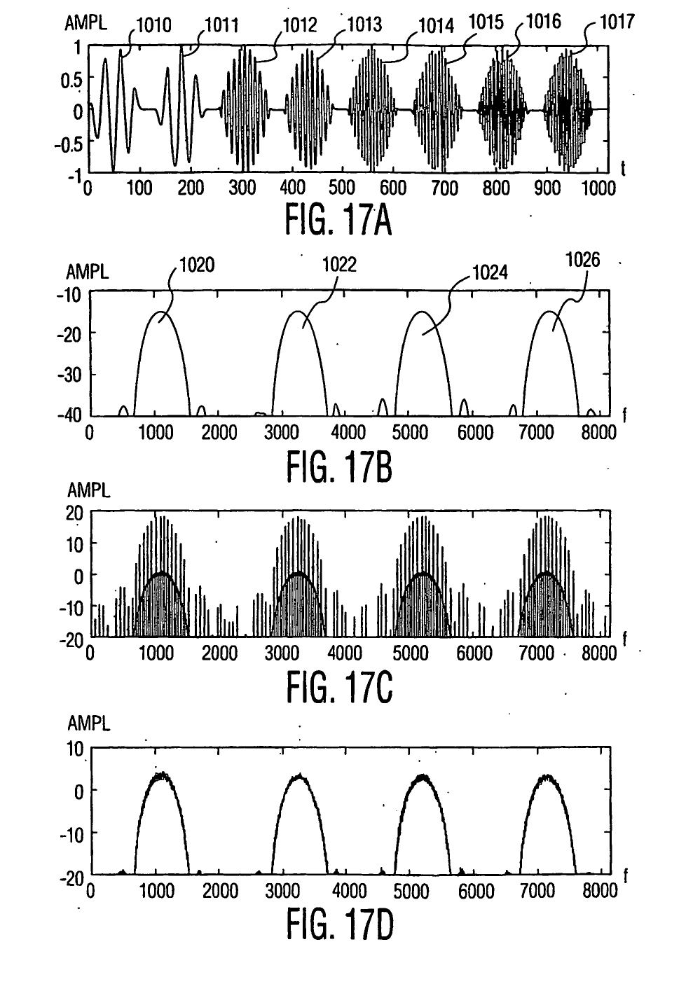

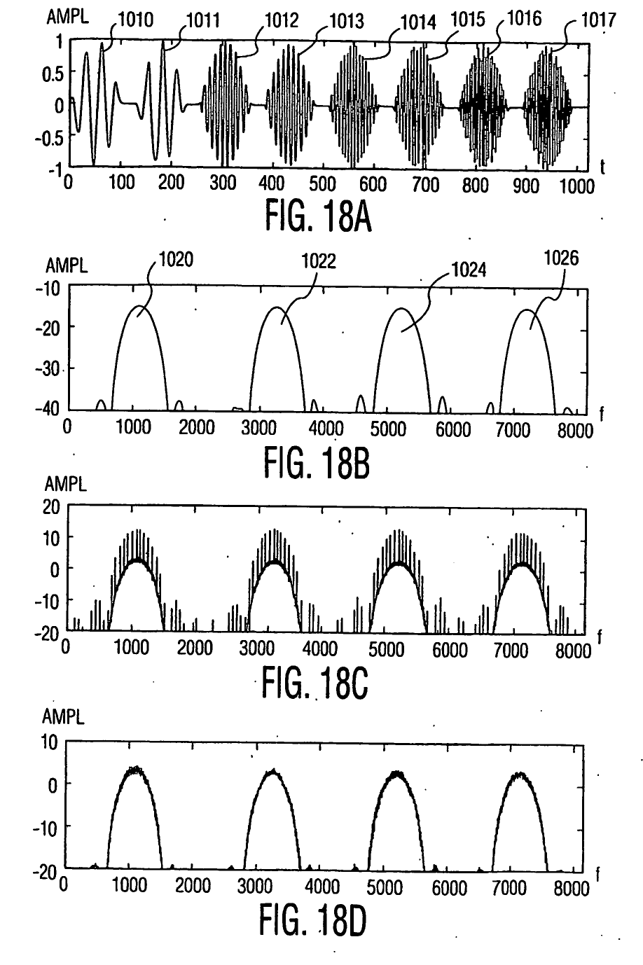

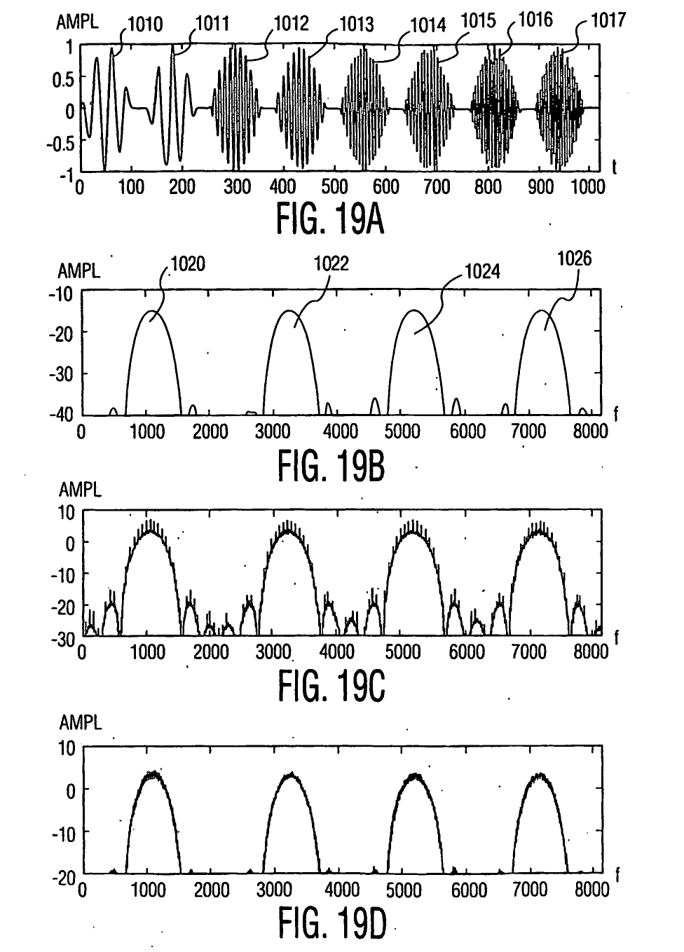

In a QPSK modulation, on the other hand, each sub-band has two waveforms that have same frequency but different initial phases and each waveform may appear in two ways: normal shape and phase reversed shape. Exemplary QPSK waveforms are shown in FIG. 14A. In FIG. 14A, waveforms 1010 and 1011 are the two waveforms in the first sub-band with waveform 1011 being phase shifted with respect to waveform 1010. The inverted versions of these waveforms are not shown in FIG. 14. In the same way, the waveform pairs, 1012, 1013; 1014, 1015; and 1016, 1017 represent the two relatively phase shifted waveforms for three other sub-bands. The energy spectral density for these waveforms is shown in FIG. 14B, with the spectrum 1020 corresponding to the waveform pair 1010, 1011 and the spectra 1022, 1024 and 1026 corresponding to the respective waveform pairs 1012, 1013; 1014, 1015; and 1016, 1017. These waveforms are the same for FIGS. 14, 15, 16, 17, 18 and 19 and are only described with reference to FIG. 14.

The mechanism of the present invention, as described above, may be used with QPSK modulation technique with a modification of equations (3) and (4) as shown in equations (19), (20) and (21).

$$\begin{matrix}Pr \{ {w}_{n} \} = {p}_{n} , n = 1 , … , {N}_{q} & ( 19 ) \\ {\sum }_{n = 1}^{{N}_{q}} {p}_{n} = 1 & ( 20 ) \\ {N}_{q} = 2 N & ( 21 )\end{matrix}$$

FIGS. 14, 15, 16, 17, 18 and 19 show the results of simulations performed to show that applying the operation proposed in equation (16) and (17) effectively suppresses line spectra and reduces the PSD of multi-band QPSK UWB signals. Configuration of the simulations are the same as those described above with reference to FIGS. 8-13. In particular: the sub-bands are evenly and randomly used in the simulations shown in FIGS. 14-16 and the sub-bands are rotationally used in the simulations shown in FIGS. 17-19. In each sub-band, one of two waveforms is randomly picked but both waveforms are chosen with equal probability.

As described above, FIGS. 14-19 illustrate different configurations of sequencing of the waveform pairs 1010, 1011; 1012, 1013; 1014, 1015; and 1016, 1017. FIGS. 14-16 show cases in which the various waveform pairs are randomly selected and FIGS. 17-19 show cases in which the waveform pairs are sequentially and rotationally selected. FIGS. 14-19 also represent different distributions of the probability function p of the random variable {aₙ}. in particular, FIGS. 14 and 17 represent cases in which p=1; FIGS. 15 and 18 show cases In which p=0.25; and FIGS. 16 and 19 show cases in which p=0.4.

The results shown In FIGS. 14-19 indicate that, using the mechanism of the present invention:

QPSK systems exhibit lower PSD by 2-3 dB than corresponding BPSK systems with the same configuration;

Random utilization of sub-bands reduces the number of spectral lines compared with rotational use of sub-bands. The peaks of the PSDs for the various sub-bands (shown, for example, in FIG. 14B), however, is almost the same;

Selective phase Inversion effectively removes line spectra in all cases no matter how sub-bands are utilized, as shown in FIGS. 14D, 15D, 16D, 17D, 18D, and 19D;

Using a mechanism according to the present invention, peak values of the PSD are reduced from about from 19 dB to 4 dB in FIGS. 14 and 17, from 13 dB to 4 dB In FIGS. 15 and 18, and from 6 dB to 4 dB in FIGS. 16 and 19;

The shape of the PSDs of the new data, shown in FIGS. 14D, 15D, 16D, 17D, 18D, and 19D, is very close to that of the pulse used, shown in FIGS. 14B, 15B, 16B, 17B, 18B, and 19B, respectively;

With the equal use of all sub-bands, the PSDs of all sub-bands have almost the same magnitude.

A mechanism has been described, which uses base-band processing to remove lines in the spectrum and, thus, to reduce the peak value of the PSD of multi-band UWB signals. Simulations show that the proposed approach is effective in suppressing the PSD of multi-band UWB signals. In addition, it satisfies the important practical criteria of being both simple and easy to implement.

Although the components of the present invention have been described in terms of specific components, it is contemplated that one or more of the components may be implemented in software running on a computer. In this embodiment, one or more of the functions of the various components may be implemented in software that controls the computer. This software may be embodied in a computer readable carrier, for example, a magnetic or optical disk, a memory-card or an audio frequency, radio-frequency or optical carrier wave.

Further, although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A signal processing method for processing data for transmission that reduces discrete components of a transmitted multi-band wideband signal including the processed data, each band of the multi-band wideband signal including waveforms corresponding to a different band of frequencies, the method comprising the steps of:
selectively inverting the data;
defining a sequence for modulating the bands of the multi-band wideband signal with the data; and
modulating the data onto the waveforms within the bands of the multi-band wideband signal in accordance with the defined sequence.

2. The method of claim 1, wherein the defined sequence is sequential.

3. The method of claim 1, wherein the defined sequence is random.

4. The method of claim 1, wherein the modulating step comprises the step of:
modulating the selectively inverted data onto the waveforms within the bands of the multi-band wideband signal in accordance with the defined sequence.

5. The method of claim 1, wherein the selectively inverting step comprises the step of:
selectively inverting the modulated waveforms.

6. A signal processing system to process data for transmission that reduces discrete components of a multi-band wideband signal including the processed data, each band of the multi-band wideband signal including waveforms corresponding to a different band of frequencies, the system comprising:
means for selectively inverting the data;
means for defining a sequence for modulating the bands of the multi-band wideband signal with the data; and
means for modulating the data onto the waveforms within the bands of the multi-band wideband signal in accordance with the defined sequence.

7. The system of claim 6, wherein the defined sequence is sequential.

8. The system of claim 6, wherein the defined sequence is random.

9. The system of claim 6, wherein the modulating means comprises:
means for modulating the selectively inverted data onto the waveforms within the bands of the multi-band wideband signal in accordance with the defined sequence.

10. The system of claim 6, wherein the selectively inverting means comprises:
means for selectively inverting the waveforms modulated with the data.

11. A signal processing apparatus to process data for transmission that reduces discrete components of a multi-band wideband signal including the processed data, each band of the multi-band wideband signal including waveforms corresponding to a different band of frequencies, the apparatus comprising:
an inverter configured to selectively invert the data;
a modulator coupled to the inverter, the modulator configured to modulate the waveforms within the bands of the multi-band wideband signal with the data in accordance with a defined band mapping sequence.

12. The apparatus of claim 11, wherein the defined band mapping sequence is sequential.

13. The apparatus of claim 11, wherein the defined band mapping sequence is random.

14. The apparatus of claim 11, wherein the modulator is configured to modulate the selectively inverted data onto the waveforms within the bands of the multi-band wideband signal in accordance with the defined sequence.

15. The apparatus of claim 11, wherein the inverter is configured to selectively invert the waveforms modulated with the data.

16. A computer readable carrier including software that is configured to control a computer to implement a signal processing method embodied in a computer readable medium to process data for transmission that reduces discrete components of a multi-band wideband signal including the processed data, each band of the multi-band wideband signal including waveforms corresponding to a different band of frequencies, the processing method including the steps of:
selectively inverting the data;
defining a sequence for modulating the bands of the multi-band wideband signal with the data; and
modulating the data onto the waveforms within the bands of the multi-band wideband signal in accordance with the defined sequence.

17. The computer readable carrier of claim 16, wherein the defined sequence is sequential.

18. The computer readable carrier of claim 16, wherein the defined sequence is random.

19. The computer readable carrier of claim 16, wherein the modulating step for implementation by the computer comprises the step of:
modulating the selectively inverted data onto the waveforms within the bands of the multi-band wideband signal in accordance with the defined sequence.

20. The computer readable carrier of claim 16, wherein the selectively inverting step for implementation by the computer comprises the step of:
selectively inverting the modulated waveforms.
